(19) United States
(12) Patent Application Publication
(10) Pub. No.: US 2021/0057970 A1
(43) Pub. Date: Feb. 25, 2021

(54) ACTIVE PART FOR AN ELECTRICAL MACHINE COMPRISING A COIL WITH PREFABRICATED PUSH-ON ELEMENTS AND CONNECTING ELEMENTS, ELECTRICAL MACHINE, AND METHOD OF PRODUCTION

(71) Applicant: Rolls-Royce Deutschland Ltd & Co KG, Blankenfelde-Mahlow (DE)

(72) Inventors: Olaf Otto, Ottobrunn (DE); Frank Anton, Erlangen (DE); Harald Müller, Gerhardhofen (DE)

(21) Appl. No.: 16/965,486

(22) PCT Filed: Jan. 22, 2019
(86) PCT No.: PCT/EP2019/051460

§ 371 Date: Jul. 28, 2020

(30) Foreign Application Priority Data
Jan. 30, 2018 (DE) 10 2018 201 345.4

(51) Int. Cl. H02K 15/04; H02K 3/28

(52) U.S. Cl. CPC H02K 15/0414; H02K 3/28

(57) ABSTRACT

The disclosure relates to an active part for an electrical machine, wherein the active part includes: a plurality of teeth and a plurality of coils, wherein a coil of the plurality of coils is arranged on each of the teeth, wherein each of the coils has a plurality of prefabricated push-on elements arranged adjacent to one another on the tooth and enclose the tooth in parts, and wherein each of the coils has a plurality of prefabricated connecting elements each for electrically connecting two adjacent push-on elements.

The present patent document is a § 371 nationalization of PCT Application Serial No. PCT/EP2019/051460, filed Jan. 22, 2019, designating the United States, which is hereby incorporated by reference, and this patent document also claims the benefit of German Patent Application No. 10 2018 201 345.4, filed Jan. 30, 2018, which is also hereby incorporated by reference.

### TECHNICAL FIELD

The present disclosure relates to an active part for an electrical machine, wherein the active part includes a plurality of teeth and a plurality of coils arranged on the respective teeth. The present disclosure further relates to an electrical machine including an active part of this kind. The present disclosure also relates to a method for producing an active part of this kind.

### BACKGROUND

Active parts for electrical machines are of interest in the present case. An active part may be a stator or a rotor of an electrical machine. The prior art discloses active parts which have a plurality of coils. These coils are formed from a wire and are wound onto corresponding teeth of the active part. It is further known to produce the respective coils from a flat wire because this is advantageous in comparison to round wires from an electrical and/or electromagnetic point of view. When a coil is produced from a flat wire, the winding process is slow and difficult to carry out to a high quality. For example, the bending radius, under which damage occurs, is geometrically limited, as a result of which the tooth width and the geometric wire cross section are limited. Furthermore, there are significant distances between the tooth and the wire, as a result of which the electromagnetic field is adversely affected. It is not possible to reproduce or repeat the process either. In addition, damage to the insulation on the wire cannot be identified by currently existing tests. A further disadvantage may be considered that of a continuous wire winding making it difficult to establish a plurality of separate voltage circuits on the tooth. Furthermore, individual turns cannot be replaced or repaired in the event of faults, for example a short between turns, occurring in existing interconnections. If this is possible at all, it is necessary to remove the entire coil with a very high level of expenditure. In addition, an individual coil, and therefore the individual turns, cannot be tested given the conventional interconnection geometry with a star point. In addition, the end piece of the tooth, the so-called “end winding” which supports the bending radius, takes up additional space in which no useful electromagnetic force is generated, and the active length of the tooth is effectively limited.

Mechanical solutions are known in order to reduce the distances between the tooth and the wire, but these mechanical solutions do not provide a complete solution. Winding automation with the aid of machines is used for this purpose, for example. It is also known to correspondingly press the wires. In order to improve the ability to reproduce and/or repeat the process, it is known to carry out winding automation or to record the winding process using photographic methods. Otherwise, there are still no solutions to the abovementioned problems to date.

In addition, it is known from the prior art to prefabricate parts of the winding of the active part and to fit the parts onto a stator or rotor. For example, so-called hairpin turns, which are inserted into a stator with a hole as individual turns, are known.

### SUMMARY AND DESCRIPTION

The object of the present disclosure is to present a solution in respect of how an active part of an electrical machine including coils arranged on teeth, may be provided in a simple manner, so that efficient operation of the electrical machine may be achieved.

According to the disclosure, this object is achieved by an active part, by an electrical machine, and by a method disclosed herein. The scope of the present disclosure is defined solely by the appended claims and is not affected to any degree by the statements within this summary. The present embodiments may obviate one or more of the drawbacks or limitations in the related art.

An active part for an electrical machine includes a plurality of teeth and a plurality of coils arranged on the respective teeth. In this example, the respective coils have a plurality of prefabricated plug-on elements arranged next to one another on the tooth and surround the tooth in regions. The respective coils further have a plurality of prefabricated connecting elements for electrically connecting, in each case, two plug-on elements arranged next to one another.

The active part may be a stator or a rotor of the electrical machine. This active part may have a laminated core, which has the plurality of teeth. According to the present disclosure, the respective coils are not formed by a continuous wire but rather by the plurality of plug-on elements and the plurality of connecting elements. Both the plug-on elements and also the connecting elements are prefabricated or fabricated such that they are matched to the profile or the outer contour of the tooth. During production of the coil, the prefabricated plug-on elements are first pushed onto the tooth and these are then electrically connected to the respective connecting elements and combined to form the desired electrical circuit. In this example, the respective plug-on elements are arranged next to one another or one above the other in the radial direction of the tooth. In each case, two plug-on elements arranged next to one another may be electrically connected to one another by way of one of the connecting elements. The electrical connection of the plug-on elements to the respective connecting elements then produces the coil of the active part overall. The respective coils together form the winding of the active part. Therefore, it is not necessary for the entire coil to be wound from a single wire. The problems mentioned at the outset may be solved in this way. In addition, simple manufacture of the respective coils may be rendered possible.

The plurality of plug-on elements and the plurality of connecting elements each may have a rectangular cross section. The plug-on elements and the connecting elements may be manufactured from a metal, for example, copper or aluminum. The respective plug-on elements and the respective connecting elements may therefore have a cross section which is known from flat wires. In this example, provision may be made for the plug-on elements and the connecting elements to each have the same cross section. The electrical and/or the electromagnetic advantages which are known from flat wires may be achieved in this way.

According to one embodiment, the plurality of plug-on elements and the plurality of connecting elements are prefabricated in such a way that they bear against an outer contour of the tooth at least in regions. As already explained above, the shaping of the plug-on elements and/or of the connecting elements is matched to the shaping or the profile of the tooth. Therefore, it is possible, in particular, for the respective plug-on elements and/or the respective connecting elements to bear against the outer contour of the tooth for the most part. In particular, provision is made for the respective plug-on elements and/or the respective connecting elements to bear against the tooth completely. Therefore, the electromagnetically disadvantageous distance between the tooth and the turns of the coil, wherein a turn is formed by a plug-on element and a connecting element, may be reduced.

In a further embodiment, the respective plug-on elements are of U-shaped design and have a central region and two limb regions, wherein the central region bears against a transverse side of the tooth and the two limb regions bear against respective longitudinal sides of the tooth at least in regions. The region of the tooth on which the coil is arranged may have a cuboidal shape with two opposite transverse sides and two opposite longitudinal sides. The respective plug-on elements have the central region which bears against one of the transverse sides. Furthermore, the respective plug-on elements have the limb regions arranged substantially perpendicularly in relation to the central region. The plug-on element may have a corresponding curvature or a radius between the central region and the respective limb regions. In this example, the respective limb elements may bear against the full longitudinal side or a portion thereof. In other words, the respective plug-on elements are manufactured so as to mechanically match the required size and shape. This additionally allows potential use of tooth geometries which cannot be achieved at present.

In one embodiment, the limb regions of the respective plug-on elements run parallel in relation to a base surface of the tooth. In this example, all limb regions of the plug-on elements arranged on the tooth run parallel in relation to one another. In this example, the connecting elements, which electrically connect in each case two adjacent plug-on elements to one another, run obliquely in relation to the base surface of the tooth. The coil may be provided in this way.

In an alternative embodiment, at least one limb region of the respective plug-on elements runs obliquely in relation to a base surface of the tooth. In certain examples, a limb region of the respective plug-on elements runs parallel in relation to the base surface of the tooth. The other limb region may run obliquely or diagonally in relation to this base surface. For example, the limb regions of the respective plug-on elements, which are arranged on one of the longitudinal sides, may run obliquely in relation to the base surface of the tooth. In this example, the respective limb regions run parallel in relation to one another on a longitudinal side of the tooth. The respective connecting elements, which connect the adjacent plug-on elements to one another, may run parallel in relation to the base surface of the tooth. The coil may also be produced in a simple and reliable manner in this way.

In a further refinement, the respective connecting elements are of U-shaped design and have a central region and two limb regions, wherein the central region bears against a transverse side of the tooth and the two limb regions bear against respective longitudinal sides of the tooth at least in regions. The respective connecting elements may also be of U-shaped design. In this example, one of the plug-on elements and one of the connecting elements, which are connected to one another, circumferentially surround the tooth. In this example, the central region of the U-shaped plug-on element bears against a first transverse side. The two limb regions of the plug-on element each extend over a region of the longitudinal sides of the tooth. The central region of the U-shaped connecting element bears against a second or opposite transverse side of the tooth. The two limbs of the connecting element extend as far as the respective limbs of the plug-on element. In this example, a limb of the plug-on element is connected to a limb of the connecting element. The coil arranged on the tooth may be provided in this way, without the threat of damage to the individual parts when the coil is fitted.

In an alternative embodiment, the respective connecting elements are of straight design and bear against a transverse side of the tooth. The respective plug-on element is also of U-shaped design in this example. Here, the central region of the plug-on element bears against a first transverse side. The respective limb regions of the plug-on element extend over the full side surfaces of the tooth. The connecting element, which is of straight design, extends along the second transverse side of the tooth. A limb region of the plug-on element is configured to be connected to a side of the connecting element in order to provide a turn of the coil. This allows rapid manufacture of the coil.

In a further refinement, the plurality of connecting elements are arranged on a board, wherein at least one electronic component is arranged on the board. The respective connecting elements may all be arranged on the common board or plug-on board or be formed on the board or plug-on board. The board may be a printed circuit board. In this example, an electronic component, (e.g., a semiconductor component), may be arranged on this board. A plurality of semiconductor components may also be arranged on the board. This at least one electronic component may serve to control an electrical voltage which is applied to the coil or to the individual turn. The at least one electronic component may further serve to control an electric current which flows through the coil or through at least one turn. In particular, a converter circuit is formed by the at least one component. The board and/or the at least one electronic component further provide the option of interconnecting the individual turns to one another as desired. Furthermore, the option of carrying out an electrical test on the coil and/or the individual turns is provided. The at least one electronic component may be part of a measuring device.

It is further advantageous when the respective plug-on elements and the respective connecting elements are coated with an insulation at least in regions. The plug-on elements and the connecting elements may be configured and arranged on the tooth such that the electrical insulation between the individual turns of the coil is guaranteed. The respective plug-on elements and the respective connecting elements may be manufactured in a manner matched to the outer dimensions of the tooth. Subsequently, the respective plug-on elements and the respective connecting elements may be provided with a corresponding insulation. This insulation may be formed from an electrically insulating material, (e.g., a plastic). The insulation may also be a corresponding electrically insulating lacquer. In this example, the plug-on elements and connecting elements are free of an insulation in a respective contact region. This renders it possible for the plug-on elements and connecting elements to be electrically connected to one another.

The respective connecting elements may be connected to the associated plug-on elements by welding and/or soldering. As already explained, the connecting elements and the plug-on elements have corresponding contact regions at their free ends or on the limb regions in order to electrically connect the connecting elements and plug-on elements to one another. The respective connecting elements and plug-on elements may be electrically connected by a soldering process. As an alternative or in addition, a welding process, (e.g., ultrasonic welding), may be used. Furthermore, the connecting elements and the plug-on elements may be connected to one another by a plug-in connection. This is suitable, in particular, when the respective connecting elements are arranged on the common board. In this example, openings may be provided in the respective board, wherein the free ends or contact regions of the plug-on elements are inserted into the openings. As an alternative to this, an electrically conductive adhesive may be used in order to electrically connect the connecting elements and the associated plug-on elements to one another. After the connecting elements are connected to the associated plug-on elements, the contact regions of the connecting elements and/or plug-on elements may once again be coated with a corresponding insulation.

In a further refinement, the respective teeth have, on a top side, at least one opening for inserting a tool for welding and/or soldering. The region of the tooth to which the coil is fitted may have a cuboidal design. The tooth may have a respective plate-like limiting element on a top side and a bottom side, the topmost turn and, respectively, the bottommost turn of the coil bearing against the limiting element. At least one opening may be provided in the limiting element arranged on the top side, it being possible for a tool for soldering and/or welding the connecting elements and plug-on elements to be inserted through the opening at least in regions. This simplifies mounting of the coil onto the respective teeth.

Additional guide elements may be arranged on the tooth, the arrangement of the plug-on elements and/or of the connecting elements on the tooth being prespecified by the additional guide elements. This is suitable particularly when the limb regions of the plug-on elements run obliquely in relation to the base surface of the tooth. An insulation element, (e.g., formed from a plastic), may further be pushed onto the tooth. Subsequently, the plug-on elements and the connecting elements may be pushed onto this insulation element. An electrical insulation between the plug-on elements and/or the connecting elements on the one hand and the tooth on the other hand may be prevented in this way.

An electrical machine includes an active part, wherein the active part is a stator or a rotor of the electrical machine. The electrical machine is, in particular, an electrical machine with a high-power density. The electrical machine may be used in manufacture, an installation, or in a robot, for example. In particular, the electrical machine may be used for driving a vehicle. The electrical machine may be used as a drive in an electric vehicle, a boat, a submarine, or the like, for example. The electrical machine may be used as a drive in an electric aircraft or electrically driven aircraft.

A method is provided herein for producing an active part for an electrical machine. The method includes manufacturing a plurality of coils and fitting the coils onto respective teeth of the active part. In this example, provision is made, for manufacturing the respective coils, for a plurality of plug-on elements to be prefabricated, and for them to be arranged next to one another on the tooth in such a way that they surround the tooth in regions. Furthermore, for manufacturing the respective coils, a plurality of connecting elements are prefabricated and, in each case, two plug-on elements arranged next to one another are electrically connected to one of the connecting elements.

Here, the plurality of plug-on elements and the plurality of connecting elements may be punched out of a main body and an insulation may be applied to the plurality of plug-on elements and the plurality of connecting elements at least in regions. The main body from which the plug-on elements and/or connecting elements are manufactured may be a metal plate. The plug-on elements and/or connecting elements may be punched out of this metal plate in the desired shape which is matched to the outer contour of the tooth. Subsequently, the plug-on elements and connecting elements may be provided with the insulation. In this example, the insulation may not be applied in the contact regions in which the connecting elements are connected to the plug-on elements. This allows simple and cost-effective manufacture of the coil of the active part.

The embodiments presented with respect to the active part and the advantages of the embodiments apply in a corresponding manner to the electrical machine and to the method disclosed herein.

### BRIEF DESCRIPTION OF THE DRAWINGS

Further features of the disclosure may be found in the claims, the figures, and the description of the figures. The features and combinations of features cited above in the description and the features and combinations of features cited below in the description of the figures and/or shown in the figures alone may be used not only in the respectively indicated combination but also in other combinations, without departing from the scope of the disclosure.

The disclosure will now be explained in more detail on the basis of exemplary embodiments and with reference to the appended drawings, in which:

FIG. 1 shows a tooth and a coil of an active part of an electrical machine according to the prior art.

FIG. 2 shows a tooth and a coil according to one embodiment.

FIG. 3 shows a side view of the tooth with the coil according to FIG. 2.

FIG. 4 shows a sectional illustration of the tooth and the coil according to FIG. 3.

FIG. 5 shows a tooth and a coil of an active part of an electrical machine according to a further embodiment.

FIG. 6 shows a side view of the tooth and the coil according to FIG. 5.

FIG. 7 shows a sectional illustration of the tooth and the coil according to FIG. 6.

FIG. 8 shows a plug-on element and a connecting element according to one embodiment, wherein a turn of the coil is formed by the plug-on element and the connecting element.

FIG. 9 shows a limiting element on a top side of the coil according to an embodiment, which limiting element has corresponding openings for inserting a tool.

FIG. 10 shows a plug-on element and a connecting element according to a further embodiment.

FIG. 11 shows a limiting element of a coil according to a further embodiment.

FIG. 12 shows a plug-on element and connecting elements which are arranged on a common board, according to an embodiment.

Identical or functionally identical elements are provided with the same reference symbols in the figures.

### DETAILED DESCRIPTION

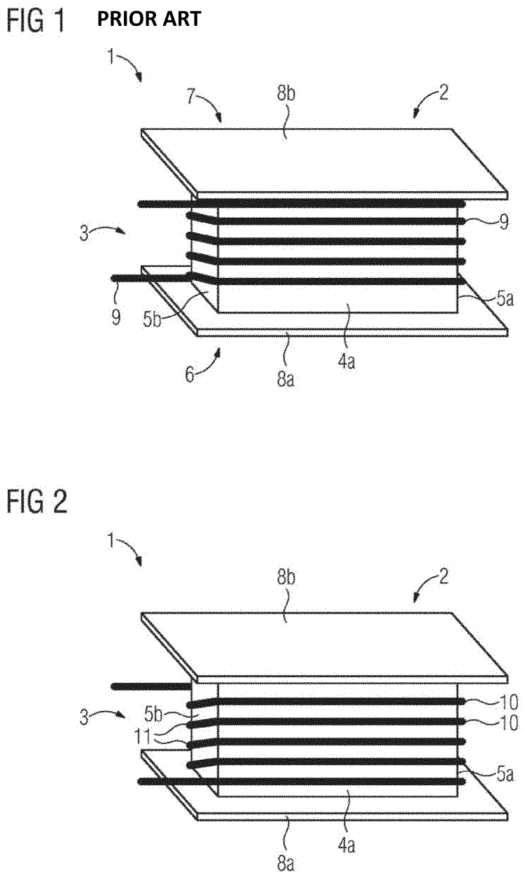

FIG. 1 shows a schematic perspective view of a tooth 2 and a coil 3 arranged on the tooth 2. The tooth 2 and the coil 3 are part of an active part 1 of an electrical machine. The active part may be a stator or a rotor of the electrical machine. The tooth 2 has a cuboidal shape in the region in which the coil 3 is arranged, and has opposite longitudinal sides 4a, 4b and opposite transverse sides 5a, 5b. Only the longitudinal side 4a may be seen in the present illustration. The tooth 2 has a lower limiting element 8a on a bottom side 6, and the tooth has an upper limiting element 8b on a top side 7. The coil 3 is fitted onto the tooth 3 between the limiting elements 8a, 8b. In the present example, the coil 3 is formed by a continuous wire 9 which is wound onto the tooth 2.

FIG. 2 shows a perspective view of a tooth 2 with a coil 3 according to one embodiment. Here, the coil 3 is designed as a straight armature winding. The coil 3 includes a plurality of plug-on elements 10 which are plugged onto the coil 2. These plug-on elements 10 are prefabricated and matched to the profile of the tooth 2 or the outer contour of the tooth 2. Furthermore, the coil 3 includes a plurality of connecting elements 11 by way of which in each case two plug-on elements 10 which are arranged one above the other are electrically connected to one another.

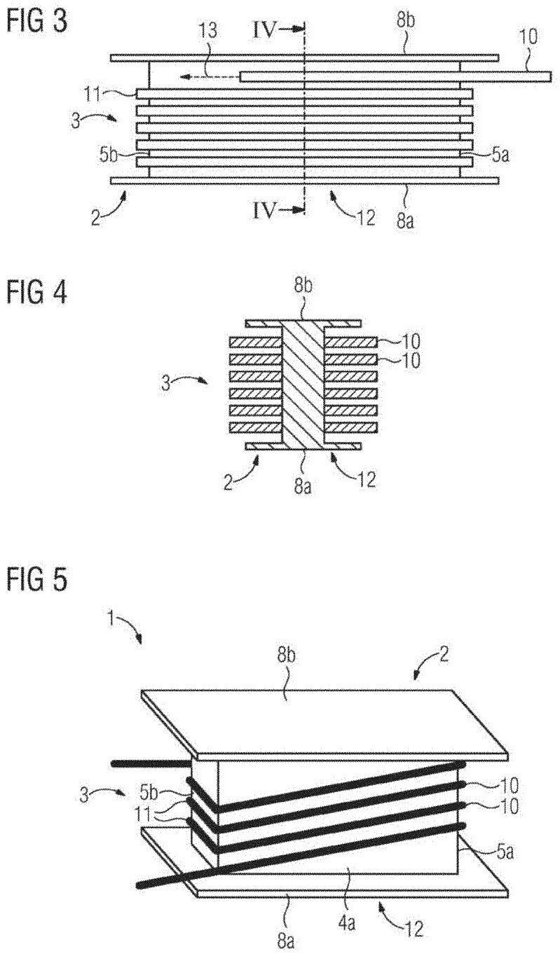

In addition, FIG. 3 shows a side view of the tooth 2 and the coil 3 according to FIG. 2. It may be seen here that the respective plug-on elements 10 run parallel in relation to a base surface 12 or parallel in relation to the limiting element 8a. The respective plug-on elements 10 are of substantially U-shaped design and are pushed onto the tooth 2 along the direction of the arrow 13. In this example, the respective plug-on elements 10 bear against the transverse side 5a completely and against the respective longitudinal sides 8a, 8b at least in regions.

FIG. 4 shows the tooth 2 and the coil 3 according to FIG. 3 along section IV-IV. It may be seen here that the respective plug-on elements 10 are arranged parallel in relation to one another and parallel in relation to the base surface 12. In addition, it may be gathered from FIG. 4 that the respective plug-on elements 10 have a rectangular cross section. In other words, the respective plug-on elements 10 are designed in the form of a flat wire. As may be seen in FIG. 2, the respective connecting elements 11 are located in the region of the transverse side 5b or the end side of the tooth 2. Here, the respective connecting elements 11 run parallel in relation to one another and in each case obliquely in relation to the base surface 12 of the tooth 2. As a result, the plug-on elements 10 which are arranged one above the other may be electrically connected to one another in order to realize the coil 3.

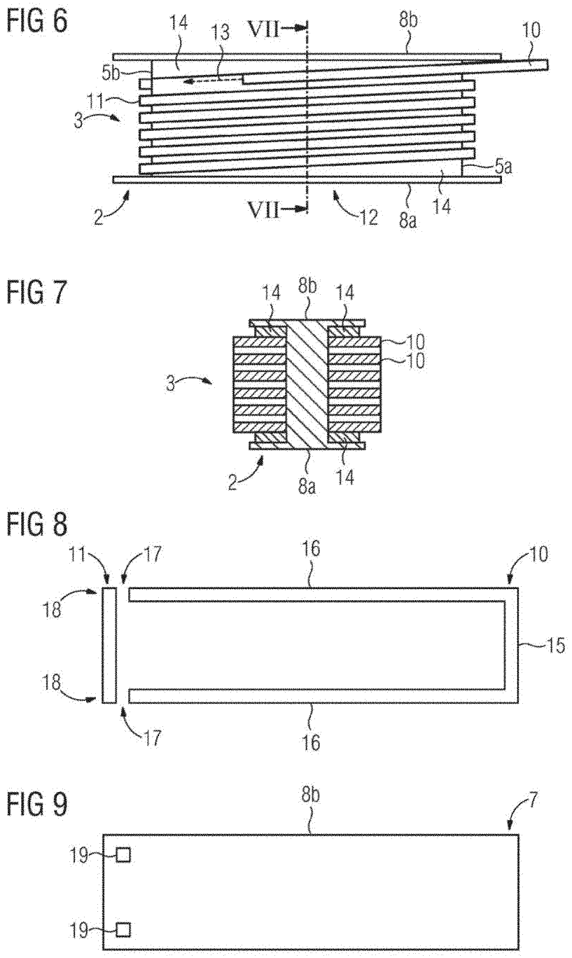

FIG. 5 shows a perspective view of a tooth 2 and a coil 3 according to a further embodiment. FIG. 6 shows the side view of the tooth 2 and the coil 3 according to FIG. 5. It may be seen here that the respective plug-on elements 10 run obliquely or diagonally in relation to the base surface 12. Additional guide elements 14 are arranged on the tooth 2, the diagonal direction of the plug-on elements 10 being prespecified by the additional guide elements. As may be gathered from FIG. 7, which shows the tooth 2 and the coil 3 according to section VII-VII from FIG. 6, the plug-on elements 10 run obliquely or diagonally in relation to the base surface 12 on the longitudinal side 4a. The plug-on elements run parallel in relation to the base surface 12 on the opposite longitudinal side 4b. As may be gathered from FIG. 5, the connecting elements 11 also run parallel in relation to the base surface 12 on the transverse side 5b. A diagonal armature winding may be provided in this way.

FIG. 8 shows a schematic illustration of a plug-on element 10 and a connecting element 11 according to one embodiment. It may be seen here that the plug-on element 10 is of U-shaped design and has a central region 15 and two limb regions 16. In this example, the limb regions 16 are arranged perpendicularly in relation to the central region 15. When the plug-on element 10 is arranged on the tooth 2, the central region 15 bears against the transverse side 5a of the tooth 2 completely. The respective limb regions 16 bear against the opposite longitudinal sides 4a and 4b completely. In this example, the connecting element 11 is of straight design and bears against the transverse side 5b completely when it is arranged on the tooth 2.

In order to produce the respective plug-on elements 10 and the connecting elements 11, the plug-on elements and connecting elements may be punched out of a main body, for example a metal sheet. Subsequently, a corresponding insulation may be applied to the plug-on elements 10 and the connecting elements 11. Thereafter, the plug-on elements 10 may be pushed onto the tooth 2 and then may be connected to the respective connecting elements 11 to form the coil 3. The respective plug-on elements 10 have contact regions 17 at the free ends of the limb regions 16. The connecting elements 11 also have corresponding contact regions 18 at their free ends. The plug-on elements 10 may be connected to the connecting elements 11 at the contact regions 17, 18. A welding process and/or a soldering process may be used in order to electrically connect the plug-on elements 10 and the connecting elements 11. In order to simplify this welding process, the limiting element 8b has corresponding passage openings 19 on the top side 7 of the tooth 2, wherein it is possible for a tool for welding and/or soldering to be inserted through the passage openings.

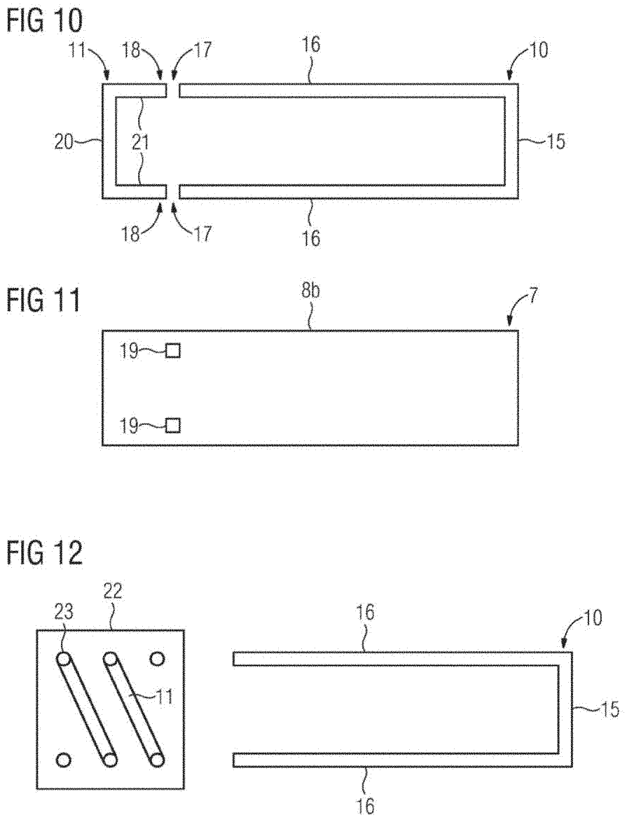

FIG. 10 shows a plug-on element 10 and a connecting element 11 according to a further embodiment. The plug-on element 10 is of substantially U-shaped design in this example too. After the plug-on element 10 is pushed onto the tooth 2, the central region 15 bears against the transverse side 5a completely. The respective limb regions 16 bear only against a region of the respective longitudinal sides 4a, 4b. In the present example, the connecting element 11 is also of U-shaped design and has a central region 20. This central region 20 bears against the transverse side 5b completely when the connecting element 11 is arranged on the tooth 2. Furthermore, the connecting element 11 includes, analogously to the plug-on element 10, corresponding limb regions 21 which bear against the longitudinal sides 4a, 4b in regions when the connecting element 11 is arranged on the tooth 2. Corresponding passage openings 19 for the tool may be provided on the limiting element 8b in a refinement of this kind of the plug-on elements 10 and the connecting elements 11 too. This is schematically illustrated in FIG. 11. As may be seen in combination with FIG. 9, the passage openings 19 are located in the region of the contact regions 17, 18 of the plug-on elements 10 and the connecting elements 11.

FIG. 12 shows a plug-on element 10 and connecting elements 11 according to a further embodiment. Here, the plug-on element 10 is of U-shaped design once again. The respective connecting elements 11, of which only two are illustrated in the present example for reasons of clarity, are arranged on a common board 22. This board 22 has corresponding openings 23 into which contact regions 17 or the free ends of the respective plug-on elements 10 may be inserted. In addition, at least one electronic component may be mounted on this board 20. The electronic component is, in particular, one or more semiconductor components. In particular, a converter circuit may be provided by these semiconductor components.

Several advantages result from the coil 3 of the active part 1 being formed by the prefabricated plug-on elements 10 and the connecting elements 11. One result is, for example, increased speed during manufacture of the coil 3 or the active part 1. A particular result is the option of pushing the respective coils 3 onto the tooth 2 in a prefabricated manner as a stack, as a result of which a considerable advantage in respect of speed is produced over single-tooth windings. In addition, fitting of the plug-on elements 10 and the connecting elements 11 may be automated. This results in lower costs owing to the simpler manufacturing method in comparison to automated methods in which a complete wire is wound onto the tooth 2.

Furthermore, the effectiveness is increased, e.g., the individual turns may be manufactured so as to exactly match the required size and shape. This allows a considerable reduction in the electromagnetically disadvantageous distance between the tooth 2 and the respective turns. A further result is long-term prevention of damage which may occur in a winding process. In addition, potential use of tooth geometries which cannot be achieved at present is rendered possible. The individual plug-on elements 10 and connecting elements 11 result in the option of interconnection of the individual coils as desired, with the prospect of increased safety during use. In addition, individual test processes on each coil 3 or the entire winding after the push-on operation may be rendered possible, this resulting in additional proof of quality. Furthermore, there is also the option of creating flat wire windings in sizes which cannot be achieved at present. In addition, the option of repairing individual turns is provided or rendered possible by this manner of interconnection. Owing to this flexible manner of connection, electrical testing is still possible even after electrical interconnection of the individual coil and furthermore the individual turns may still be tested. For example, a resistance may be measured or a surge voltage test may be carried out. In addition, the use of a board 20 provides the advantage of rapid manufacture, interconnection as desired and direct mounting of individual converters, either for each tooth 2 or for each turn.

Although the disclosure has been illustrated and described in greater detail by the exemplary embodiments, the disclosure is not restricted by these exemplary embodiments. Other variations may be derived herefrom by the person skilled in the art, without departing from the scope of protection of the disclosure. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. An active part (1) for an electrical machine, comprising:
a plurality of teeth; and
a plurality of coils arranged on the respective teeth,
wherein the respective coils have a plurality of prefabricated plug-on elements arranged next to one another on a respective tooth and surround the tooth in regions,
wherein the respective coils have a plurality of prefabricated connecting elements for electrically connecting, in each case, two plug-on elements arranged next to one another,
wherein the respective plug-on elements are of U-shaped design and have a central region and two limb regions, wherein the central region bears against a transverse side of the tooth and the two limb regions bear against respective longitudinal sides of the tooth at least in regions, and
wherein at least one limb region of the respective plug-on elements runs obliquely in relation to a base surface of the tooth, wherein the tooth has guide elements by which the oblique direction of the plug-on elements is prespecified.

2. The active part of claim 1, wherein each plug-on element of the plurality of plug-on elements and each connecting element of the plurality of connecting elements has a rectangular cross section.

3. The active part, of claim 1, wherein the plurality of plug-on elements and the plurality of connecting elements are prefabricated in such a way that the plurality of plug-on elements and the plurality of connecting elements bear against an outer contour of the tooth at least in regions.

4. The active part of claim 1, wherein the respective connecting elements are of U-shaped design and have a central region and two limb regions, wherein the central region bears against a transverse side of the tooth and the two limb regions bear against respective longitudinal sides of the tooth at least in regions.

5. The active part of claim 1, wherein the respective connecting elements have a straight design and bear against a transverse side of the tooth.

6. The active part of claim 1, wherein the plurality of connecting elements is arranged on a board, and
wherein at least one electronic component is arranged on the board.

7. The active part of claim 1, wherein the plurality of plug-on elements and the plurality of connecting elements are coated with an insulation at least in regions.

8. The active part of claim 1, wherein the respective connecting elements are connected to the associated plug-on elements by a weld or solder.

9. The active part of claim 8, wherein each tooth of the plurality of teeth has, on a top side, at least one opening for the weld or solder.

10. An electrical machine comprising:
a stator or rotor having:
a plurality of teeth, and
a plurality of coils arranged on the respective teeth,
wherein the respective coils have a plurality of prefabricated plug-on elements arranged next to one another on a respective tooth and surround the tooth in regions,
wherein the respective coils have a plurality of prefabricated connecting elements for electrically connecting, in each case, two plug-on elements arranged next to one another,
wherein the respective plug-on elements are of U-shaped design and have a central region and two limb regions, wherein the central region bears against a transverse side of the tooth and the two limb regions bear against respective longitudinal sides of the tooth at least in regions, and
wherein at least one limb region of the respective plug-on elements runs obliquely in relation to a base surface of the tooth, wherein the tooth has guide elements by which the oblique direction of the plug-on elements is prespecified.

11. The active part of claim 2, wherein the plurality of plug-on elements and the plurality of connecting elements are prefabricated in such a way that the plurality of plug-on elements and the plurality of connecting elements bear against an outer contour of the tooth at least in regions.

12. The active part of claim 11, wherein the respective connecting elements are of U-shaped design and have a central region and two limb regions, wherein the central region bears against a transverse side of the tooth and the two limb regions bear against respective longitudinal sides of the tooth at least in regions.

13. The active part of claim 11, wherein the respective connecting elements have a straight design and bear against a transverse side of the tooth.

14. The active part of claim 2, wherein the plurality of connecting elements is arranged on a board, and
wherein at least one electronic component is arranged on the board.

15. The active part of claim 2, wherein the plurality of plug-on elements and the plurality of connecting elements are coated with an insulation at least in regions.

16. The active part of claim 3, wherein the plurality of connecting elements is arranged on a board, and
wherein at least one electronic component is arranged on the board.

17. The active part of claim 3, wherein the plurality of plug-on elements and the plurality of connecting elements are coated with an insulation at least in regions.

18. The active part of claim 6, wherein the plurality of plug-on elements and the plurality of connecting elements are coated with an insulation at least in regions.
